(19) United States
(12) Patent Application Publication
(10) Pub. No.: US 2012/0182286 A1
(43) Pub. Date: Jul. 19, 2012

(54) SYSTEMS AND METHODS FOR CONVERTING 2D DATA FILES INTO 3D DATA FILES

(76) Inventor: Xiao Yong Wang, Shanghai (CN)

(21) Appl. No.: 13/006,962

(22) Filed: Jan. 14, 2011

(51) Int. Cl. G06T 15/00

(52) U.S. Cl. 345/419

(57) ABSTRACT

A data conversion system comprises a storage device for storing a user accessible digital data, and a conversion device for converting the user-accessible digital data into a 3D data object in a 3D environment. The 3D data object is capable of being created or modified by a user in the 3D environment; and a change made in the 3D data object by the user in the 3D environment is capable of being saved as the user-accessible digital data in the non-3D environment, the user-accessible digital data being capable of being further modified by the user in the non-3D environment.

### TECHNICAL FIELD

The present invention relates generally to methods and systems for users to convert two dimensional (“2D”) data objects into three dimensional (“3D”) data objects inside the same geometric space.

### BACKGROUND

Users store and interact with information in many different ways. For example, users interact with stored information on computers, televisions, phones, and other electronic devices. The interaction between the user and the information over the various mediums is commonly displayed when users store pictures on computers in digital files to access at a later time.

A user's interaction with this information is described in a two dimensional context because the relationship lacks the depth, illustration and height that are common in a user's daily interaction with data. For example, information is generally saved within subsets of folders or files on a computer's hardware. The subsets of folders are commonly saved onto a specific drive, like the C drive. Within the C drive, there may be a general music file folder, a subfolder titled by the name of the artist and a subfolder that holds the artist's music. Though this description describes one interaction of the user with information stored on the computer, the relationship between the user and the information is standard. The user is unable to interact with the information in a way that incorporates illustration and depth.

The current manner in which users interact with information is different from how a user interacts with information in a user's daily experience. A user's daily experience is reflected by the interaction with information in a three dimensional way. A three dimensional experience defined by the ability to incorporates a data object's surroundings, look, feel, height and depth. For example, a user may remember that she keeps her car keys on a small red hook beside the upper panel of the refrigerator. In this context, the user is accustomed to locating her keys because she knows they are on a hook in relation to its surroundings. In this example, the surroundings include the kitchen and location of the refrigerator.

This level of interaction is currently missing from a user's interaction with digital data. The current standard for interaction makes a user's interaction with information more foreign since it is not the way users interact with daily information. Further, users are deprived from experiencing the richness of data and their level of control over digital data is greatly limited. This invention revolutionizes the user's interaction with data by allowing users see, navigate, and interact with digital data in a way that is consistent with a user's daily interaction with information.

### SUMMARY OF THE INVENTION

Consistent with the invention, methods and systems are provided for users to convert 2D data objects into 3D data objects inside the same geometric space. In one embodiment, a data conversion system comprises a storage device for storing a user accessible digital data, and a conversion device for converting the user-accessible digital data into a 3D data object in a 3D environment. The 3D data object is capable of being created or modified by a user in the 3D environment; and a change made in the 3D data object by the user in the 3D environment is capable of being saved as the user-accessible digital data in the non-3D environment, the user-accessible digital data being capable of being further modified by the user in the non-3D environment.

In another embodiment, a method for converting data comprises storing a user-accessible digital data in a storage device, and converting the user-accessible digital data into a 3D data object.

Also consistent with the invention, a 3D visualization system, comprising a display device configured to display a user-accessible digital data into a 3D data object in a 3D environment, the digital data not being an avatar of a user; a 2D or 3D data object file storage device, a computing device configured to program the 3D coordinates of the 3D data object in relation to the 3D environment, and an input device configured to control the 3D data object in the 3D environment. The 3D data object is capable of being created or modified by the user in the 3D environment, and the corresponding user-accessible digital data can be stored in the computing device and modified by the user in a non-3D environment. The input device is capable of being used to locate the 3D data object, zoom in and out the view, or navigate to other data objects.

In yet another embodiment, a method for 3D visualization comprises displaying a user-accessible digital data into a 3D data object in a 3D environment, the digital data not being an avatar of a user; programming the 3D coordinates of the 3D data object in relation to the 3D environment, and controlling the 3D object in the 3D environment.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments;

FIG. 1 illustrates an exemplary environment in which systems and methods consistent with the present invention may be implemented;

FIG. 2A is a flowchart of an exemplary method for converting a 2D data object into a 3D data object;

FIG. 2B is a flowchart of an exemplary method for 3D visualization;

FIG. 3 illustrates an exemplary system for converting 2D data objects into 3D data objects;

FIG. 4 illustrates an exemplary environment in which the user navigates in a 3D environment and interacts with 3D data objects;

FIG. 5 illustrates an exemplary environment where a user interacting with 3D data objects on a screen, mobile device and virtual reality environment;

FIG. 6 illustrates an exemplary environment showing the 3D data objects in a 3D environment;

FIG. 7 illustrates an exemplary environment showing the 3D data objects in a 3D environment;

FIG. 8 illustrates an exemplary environment showing the 3D data objects in a 3D environment;

FIG. 9 illustrates an exemplary environment showing the 3D data objects in a mixed reality 3D environment;

FIG. 10 illustrates an exemplary environment showing the 3D data objects in a mixed reality 3D environment;

FIG. 11 illustrates an exemplary environment showing the 3D data objects in a mixed reality 3D environment;

FIG. 12 illustrates an exemplary environment showing the 3D data objects in a mixed reality 3D environment;

FIG. 13 illustrates an exemplary environment showing the 3D data objects in a mixed reality 3D environment;

FIG. 14 is an exemplary screenshot of the Adobe Flash Code for the conversion software;

FIGS. 15A-15F show a portion of an exemplary programming code for implementing the conversion from 2D data objects to 3D data objects.

### DETAILED DESCRIPTION

Reference will now be made in detail to exemplary embodiments consistent with the present invention, examples of which are illustrated in the accompanying drawings. Wherever possible, the same reference numbers will be used throughout the drawings to refer to the same or like parts. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

Systems and methods are disclosed herein for users to convert two dimensional (“2D”) data objects into three dimensional (“3D”) data objects inside the same geometric space. This graphical user interface and data visualization mechanism is designed to help users to navigate digital data either on the screen or in a simulated virtual three dimensional environment. Each set of digital data (e.g., text files, music, and any type of user content) is visualized into 3D digital data objects that are placed in a 3D environment, where the 3D coordinates of each object in relation to its environment are specified. Each 3D digital data object is programmed to relate itself to its adjacent objects in terms of left, right, front, back, top and bottom. Users can use computer input devices, including, but not limited to a mouse, keyboard, multi-touch gestures, or motion gestures to control the space as well as the objects. Further, in the 3D environment, the user can turn left or right to locate the 3D digital data objects, zoom in/out of the view, rotate the object, or navigate to other data objects.

In one embodiment, the conversion of 2D data objects into 3D data objects allows the user to interact with the information in a way that is consistent with the user's daily interaction with information. Further, users interact with the data in an environment that saves the 2D data objects in relation to the other objects in the environment and allows the user to navigate in the environment. User navigation includes, but is not limited to the ability to move forward and backward, left or right, ascend or descend, or rotate the 3D environment clockwise or counterclockwise.

The interface of the invention presents a 3D dimensional environment where multiple spaces (inside or outside) can inter-connect via hyper-links/hot spots. Users can define favorite spaces to store their files, media files and any other type of digital contents. Users can also customize the connection and hierarchy of these environments, which fully utilizes the users' memory of physical world.

The shape of the 3D data objects includes, but is not limited to designs as primitive shapes (standard primitives and extended primitives), such as cubes, cylinders and cones. The size of each primitive shape reflects the quantity of the contents. For example, the larger primitive shapes would have the most information stored. The facets of each primitive can be used as categories to facilitate users' memory. To easily manage the groups of 3D data objects, a unique number can be assigned to each primitive. If the data objects link to dynamic data, such as e-mails, SMS or downloads, the size and numeric indicator of such data objects should dynamically indicate the change.

This interface is particular useful for electronic devices including, but not limited to computers, iPads, cameras, and mobile devices, where users interact with dynamic data like SMS, conversations, social updates, shared photos, music files, and other types of information.

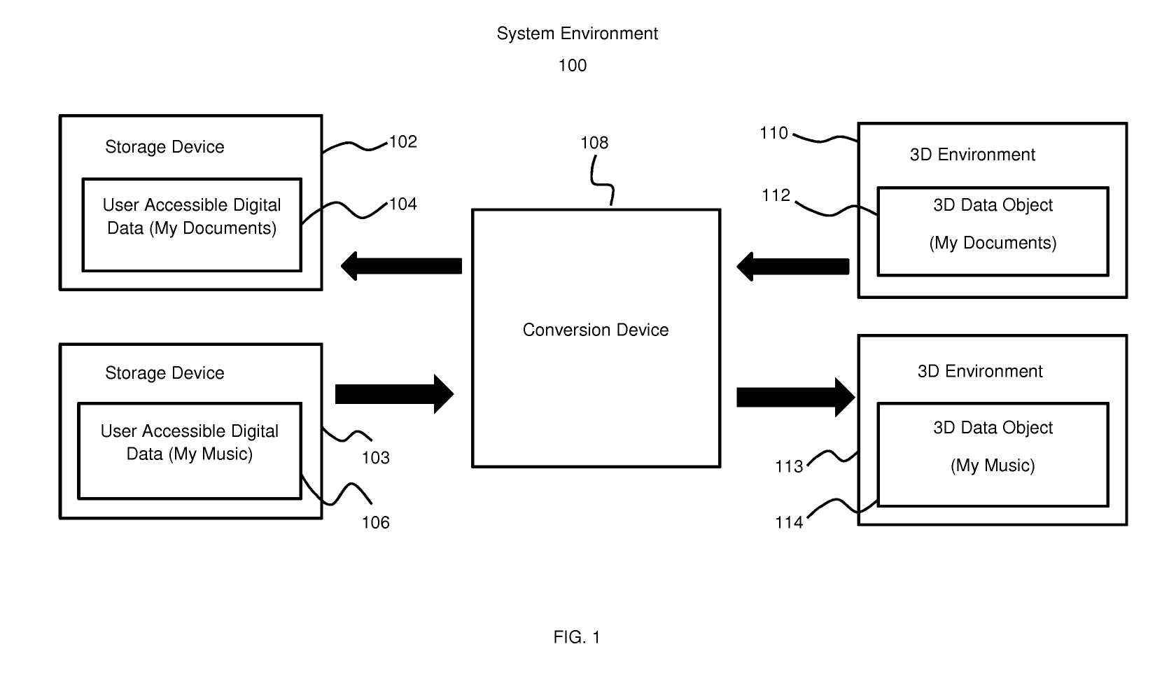

FIG. 1 illustrates an exemplary environment 100, in which the systems and methods consistent with the present invention may be implemented. The number of components in environment 100 is not limited to what is shown and other variations in the number of arrangements of components are possible, consistent with embodiments of the invention. The components of FIG. 1 may be implemented through hardware, software, and/or firmware

As shown in FIG. 1, environment 100 may include a storage device 103 and a conversion device 108. The storage device 103 may be a computer, a mobile or traditional phone, a television, a virtual reality environment and any other types of electronic mediums. The storage device 103 stores a user-accessible digital data 106, which may be a Microsoft Windows™ Word file, a music file, or a picture file. In one embodiment, the user-accessible digital data 106 is a music file, which may be created, modified, deleted by a user in the 2D environment. The user-accessible digital data 106 may be converted into a 3D data object 114 by the conversion device 108. The user may interact with the 3D data object 114 on a display device 113. The display device 110 may be a screen, a phone, a 3D environment, or any other display device.

In one embodiment, a user may interact with a 3D file data object 112 on a display device 110. The 3D file data object 112 is capable of being created or modified by the user in the 3D environment; and a change made in the 3D file data object 112 by the user in the 3D environment may be saved as the user-accessible digital data 104 in a 2D environment. The user-accessible digital data 104 is capable of being further modified by the user in the 2D environment.

In another embodiment, the conversion device 108 is capable of dynamically converting the user-accessible digital data 106 into the 3D data object 114 in a 3D environment. The conversion may be done in the real time when a user desires to view the user-accessible digital data in a 3D environment. Conversely, the conversion device 108 is capable of dynamically converting the 3D data object 112 in a 3D environment into the user-accessible digital data 104 in a 2D environment. The user-accessible digital data 104 may be a file data object, which may be an object that multiple files can relate in a defined order. The 3D environment may be displayed in at least one of a camera, a phone, a television, a computer, or on a screen. The 3D environment may also be displayed in a virtual reality environment.

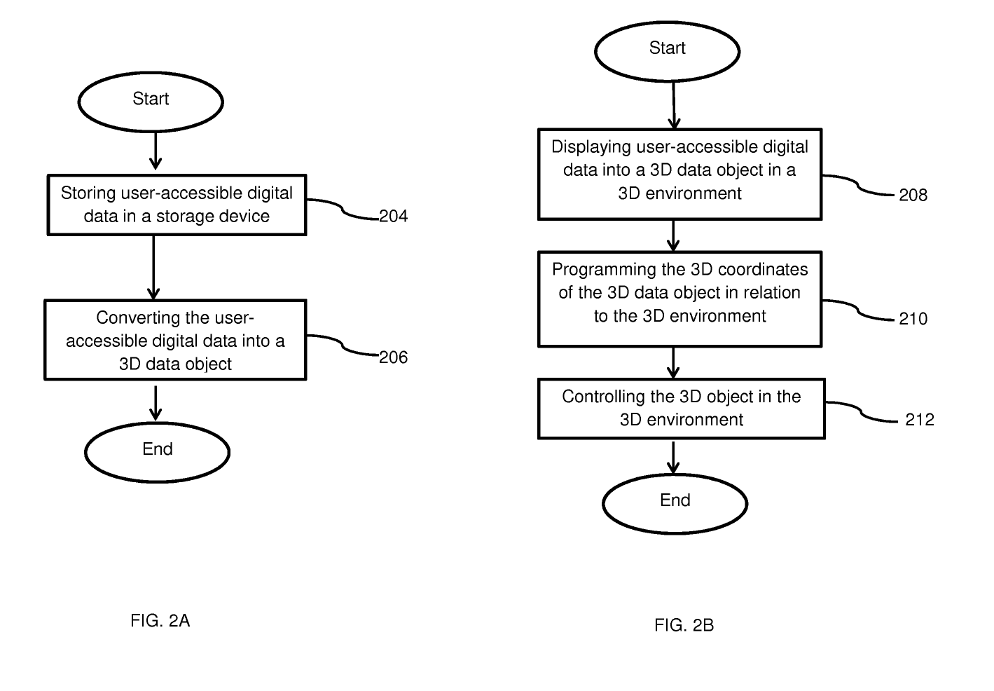

FIG. 2A shows a flowchart of an exemplary method for converting a 2D data object into a 3D data object. In one embodiment, a method for converting a 2D data object into a 3D data object comprises storing user-accessible digital data in a storage device in step 204 and then converting the user-accessible digital data into a 3D data object in step 206. A user may create and modify (including delete) the 3D data object in the 3D environment, and any change made in the 3D data object by the user in the 3D environment may be saved as the user-accessible digital data in the non-3D environment, where the user-accessible digital data may be further modified by the user in the non-3D environment.

In one embodiment, step 206 further comprises dynamically converting user-accessible digital data into the 3D data object in the 3D environment, where the conversion may be done in the real time when a user desires to view the user-accessible digital data in a 3D environment. In another embodiment, the 3D data object may relate to the user's geometric space, and the user-accessible digital data may be a file data object.

FIG. 2B outlines an exemplary method for 3D visualization. The method for 3D visualization comprises displaying user-accessible digital data into a 3D data object in a 3D environment in step 208, programming the 3D coordinates of the 3D data object in relation to the 3D environment in step 210, and controlling the 3D object in the 3D environment in step 212. A user may create or modify the 3D data object in the 3D environment, and the corresponding user-accessible digital data may be stored in the computing device and modified by the user in a non-3D environment. Moreover, step 212 further comprises locating the 3D data object, zooming in and out the view, or navigating to other data objects. Again, a user may create or modify the 3D data object is capable of being created or modified by the user in the 3D environment, and the corresponding user-accessible digital data can be stored in the computing device and modified by the user in a non-3D environment. Step 212 further comprises locating the 3D data object, zooming in and out the view, or navigating to other data objects.

In one embodiment, step 212 comprises locating the 3D data object by navigating to the left or right, forward or backward, and clockwise or counterclockwise. The user may control the 3D environment by ascending or descending the 3D data object within the 3D environment. In another embodiment, the 3D environment comprises both virtual and physical spaces, and the user-accessible digital data is a file data object or an object multiple files can relate in a defined order. In yet another embodiment, step 212 may be done by a mouse, a keyboard, a touch screen, a virtual reality sensor, a camera, or any device that can recognize controls by a human or a machine.

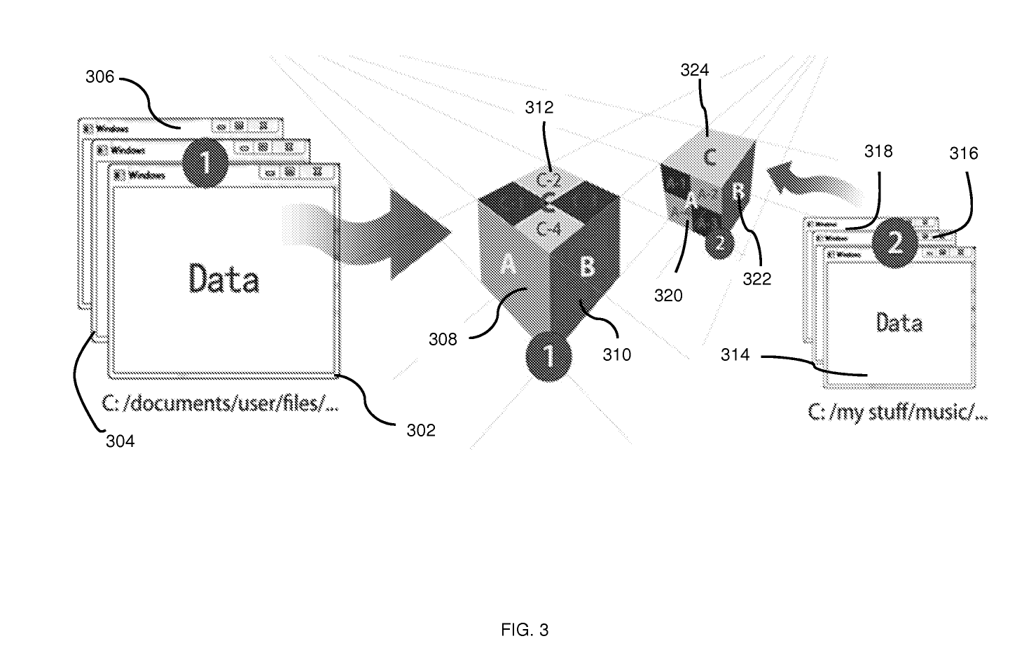

FIG. 3 illustrates an exemplary system for converting 2D data objects into 3D data objects. In one embodiment, user-accessible digital data are identified as files 302, 304, and 306 found within the user's C drive. The user-accessible digital data are then converted into 3D data objects 308, 310, and 312 in a 3D environment where the 3D data object relates to the user's geometric space. In another embodiment, a user may convert user-accessible digital music files 314, 316 and 318 into 3D data objects 320, 322, and 324 in the 3D environment.

The shape of each of the 3D data objects is represented by a cube and its size is reflective of the quantity of the information contained within. The facets of each cube can be used as categories to facilitate users' memory. To easily manage the groups of 3D data objects, a unique number can be assigned to each cube. If the data objects link to dynamic data, such as e-mails, SMS or downloads, the size and numeric indicator of such data objects should dynamically indicate the change.

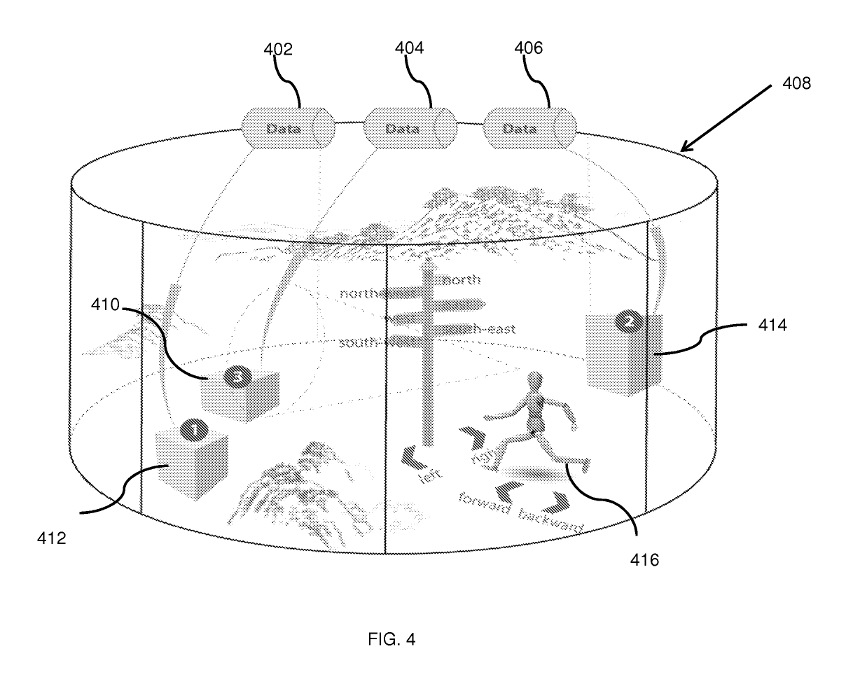

FIG. 4 illustrates an exemplary 3D environment 408 in which the user navigates in the 3D environment 408 and interacts with 3D data objects. The user-accessible digital data 402, 404 and 406 are converted into 3D digital data objects 410, 412 and 414, respectively. The user interface and data visualization mechanism is designed to help a user locate 3D digital data objects 410, 412 and 414 either on a screen or in a simulated virtual three dimensional environment 408.

Each set of digital data such as text files, music, and any type of user content is visualized into 3D digital data objects (e.g., 3D data objects 410, 412 and 414) that are placed in the 3D environment 408, where the 3D coordinates of each object in relation to its environment are specified. Further, each object is programmed to relate itself to its adjacent objects in terms of left, right, front, back, top, and bottom.

The user can use computer input devices (including mouse, keyboard, multi-touch gestures, or motion gestures) to control the space as well as the object through a user avatar 416. In the 3D environment 408, the user avatar 416 can turn left or right to locate data objects 410, 412 and 414, zoom in/out the view, rotate the object, or navigate to other data objects.

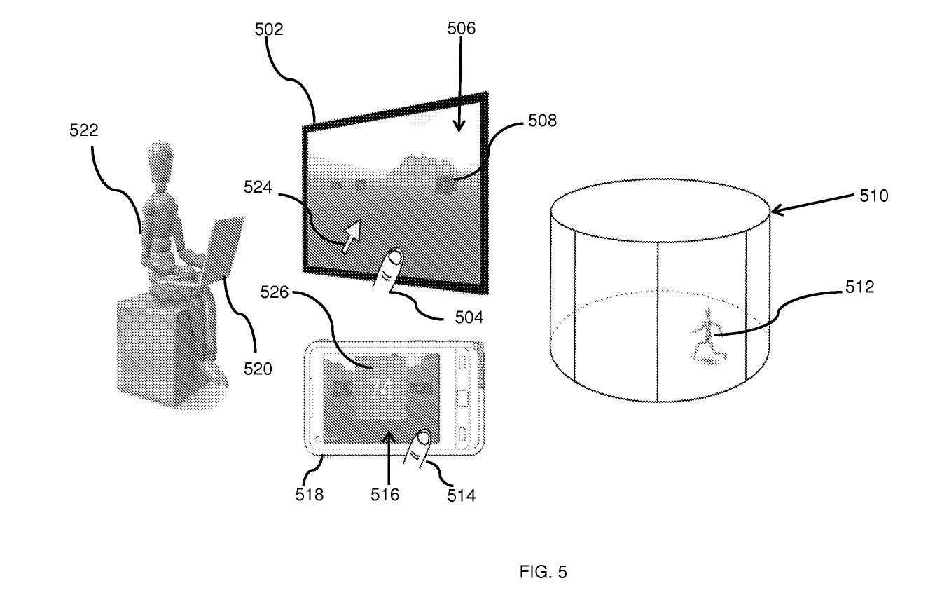

FIG. 5 shows an exemplary environment where a user 522 interacts with 3D data objects on a display screen 502, a mobile device 518, and a virtual reality environment 510. The user interface and data visualization mechanism helps the user 522 navigate throughout the 3D environment on the display screen 502, the mobile device 518, and the virtual reality environment 510 to locate the 3D digital data objects 508 and 526.

Each set of digital data is visualized into 3D data objects 508 and 526 that are placed in 3D environments 506, 516 and 510 where the 3D coordinates of each object in relation to its environment are specified. Further, each object is programmed to relate itself to its adjacent objects in terms of left, right, front, back, top and bottom. A user 522 may use computer input devices including, but not limited to a mouse 524, a keyboard 520, multi-touch gestures 504 and 514, a user avatar 512 to control the space as well as the objects. Additionally, a user 522 may use motion gestures to control the user avatar 512 or other objects. In the 3D environment, user navigation includes, but is not limited to the ability to turn left or right, zoom in/out the view, rotate the object, or navigate to other data objects.

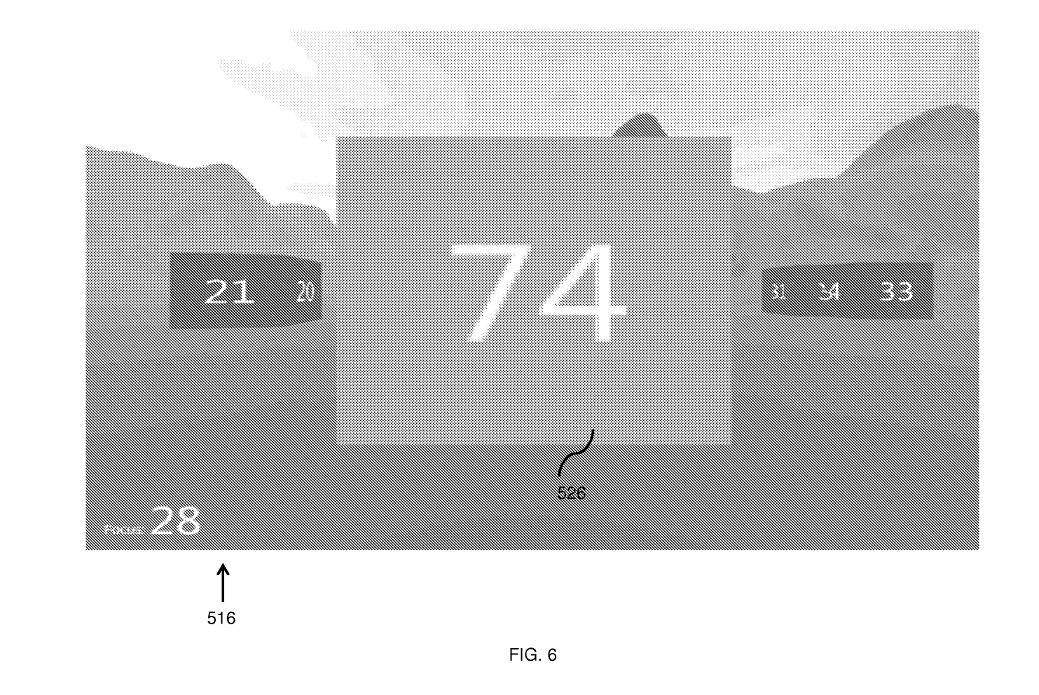

FIGS. 6-8 illustrate exemplary environments showing 3D data objects in a 3D environment. In FIG. 6, each set of digital data is visualized into 3D data objects such as 3D data object 526 that are placed in a 3D environment 516. The shape of each of the 3D data objects may be represented by a cube, as in FIG. 6, or any other shapes, and its size may be reflective of the quantity of the information contained within. The 3D coordinates of each object are identified in relation to its environment.

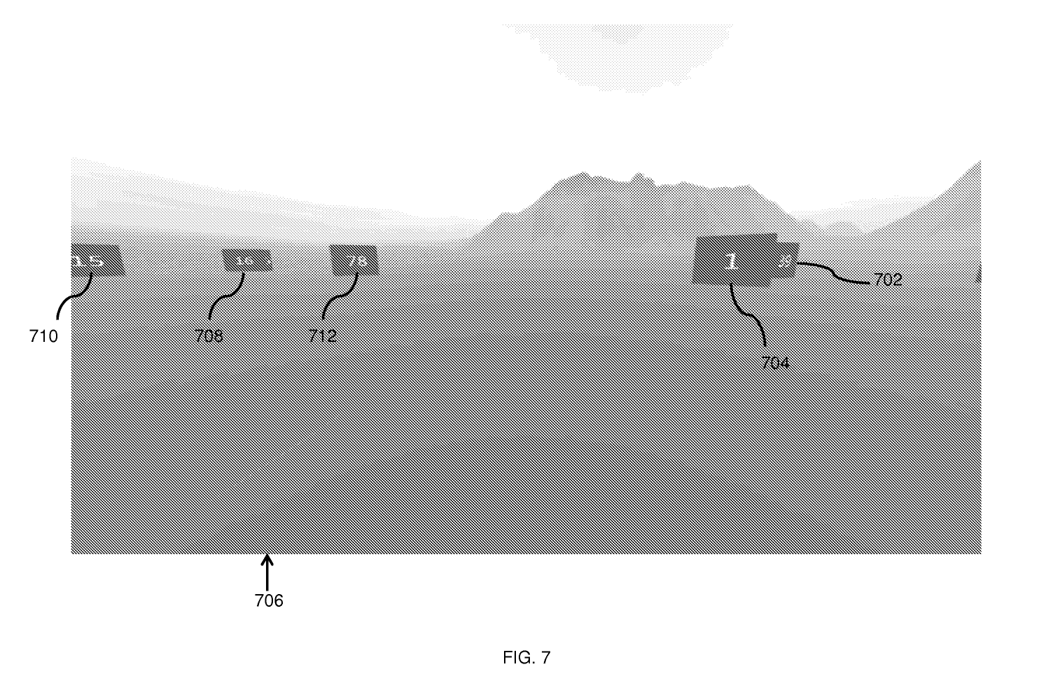

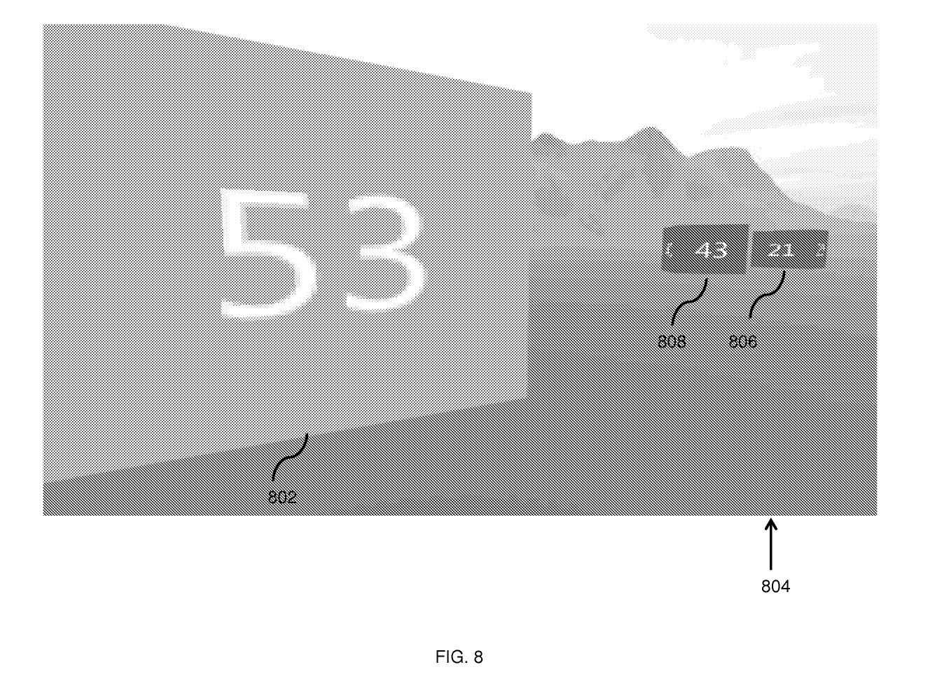

Similarly, FIG. 7 shows that digital data are visualized into 3D data objects 702, 704, 708, 710 and 712 that are placed in a 3D environment 706. In this embodiment, the shape of each of the 3D data objects is represented by a cube and its size is reflective of the quantity of the information contained within. Again, the 3D coordinates of each object are identified in relation to its environment. Similarly, FIG. 8 illustrates another exemplary environment 804 showing the 3D data objects 802, 806, and 808.

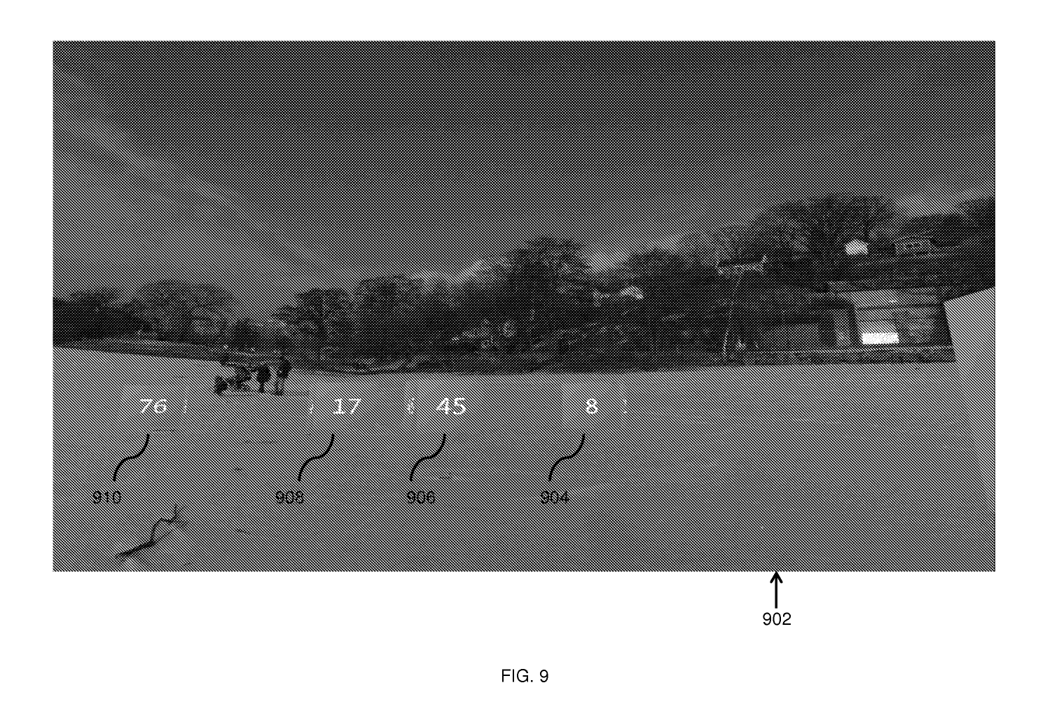

FIGS. 9-13 show the 3D data objects in a mixed reality 3D environment. In FIG. 9, digital data are visualized into 3D data objects 904, 906, 908 and 910 that are placed in a mixed reality 3D environment 902. In this embodiment, the shape of each of the 3D data objects is represented by a cube and its size is reflective of the quantity of the information contained within. The 3D coordinates of each object are identified in relation to its environment. The display of these 3D data objects is mixed with the physical environment in the background.

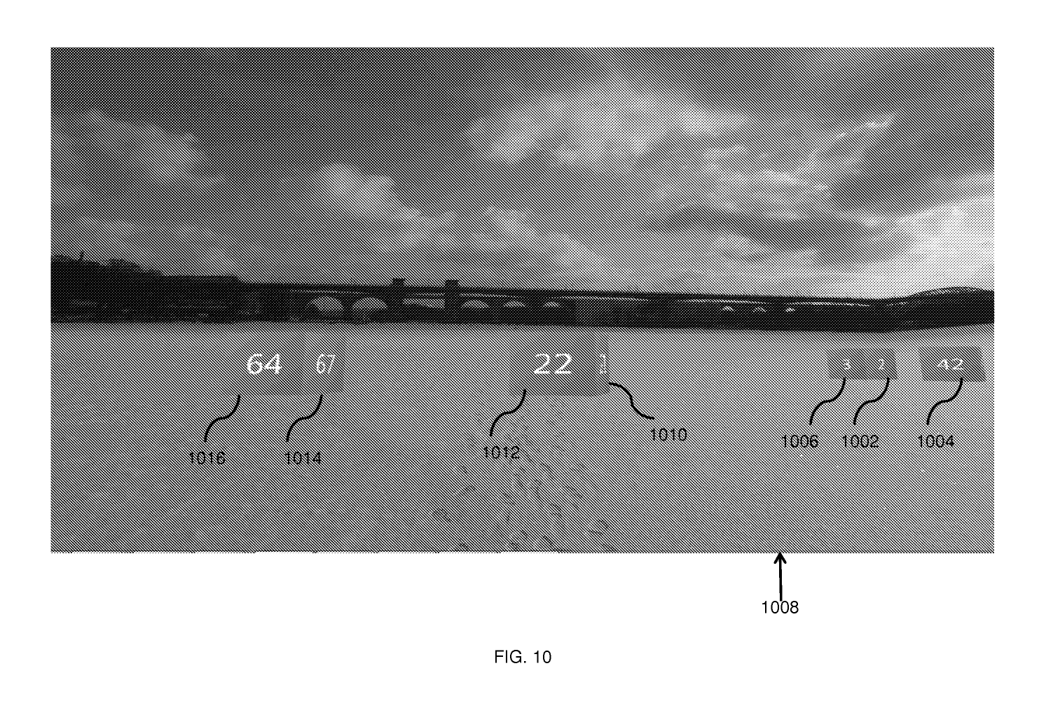

FIG. 10 shows 3D data objects 1002, 1004, 1006, 1010, 1012, 1014, and 1016 in a mixed reality 3D environment. In this embodiment, the shape of each of the 3D data objects is represented by one side of the cube and its size is reflective of the quantity of the information contained within. The 3D coordinates of each object are identified in relation to its environment and to each other. For example, 3D data objects 1014 and 1016 are represented by the same cube, which could indicate these two data objects are related files in the same folder in a 2D environment. The distance between the 3D data object 1014 and the 3D data object 1016 could indicate that these two files are far from each other in directories in a 2D environment.

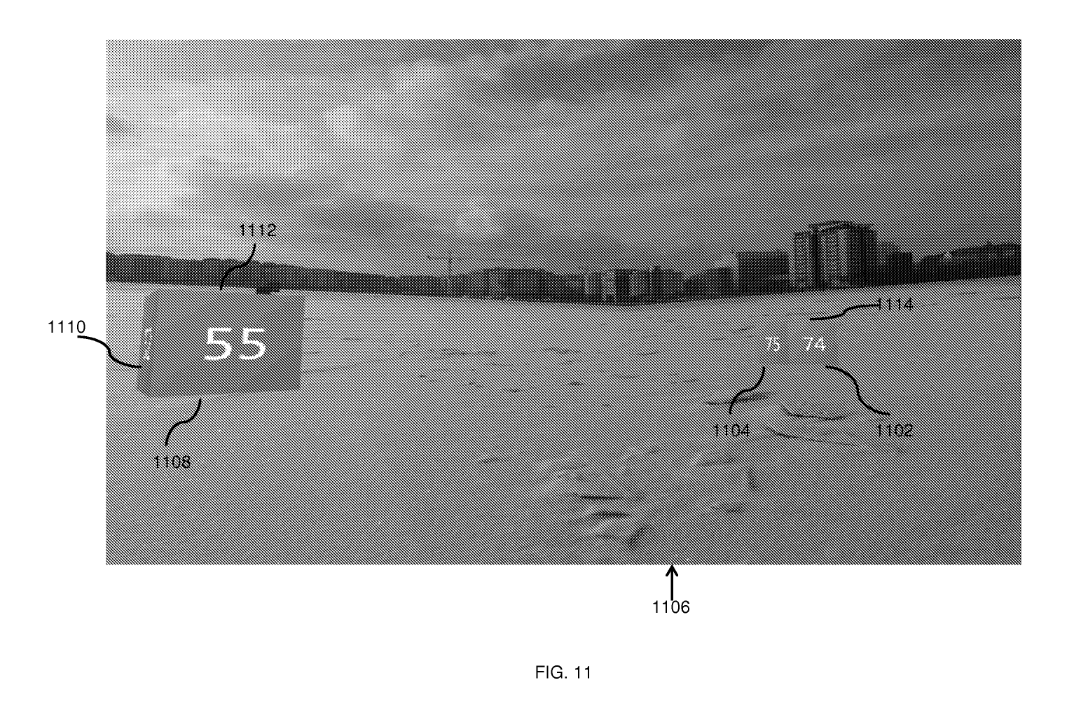

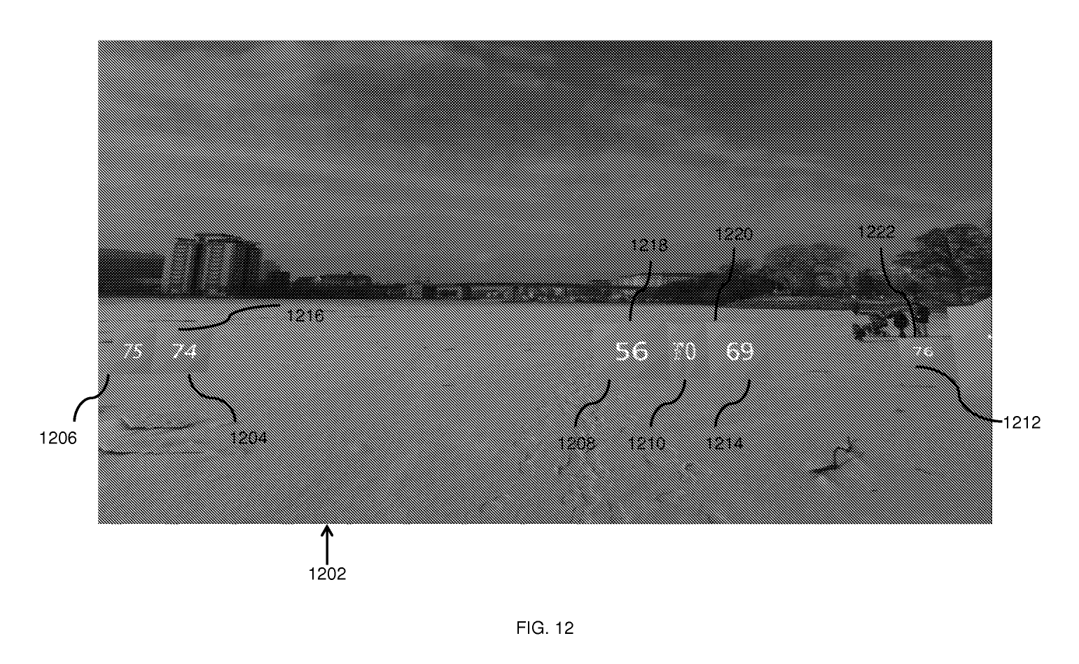

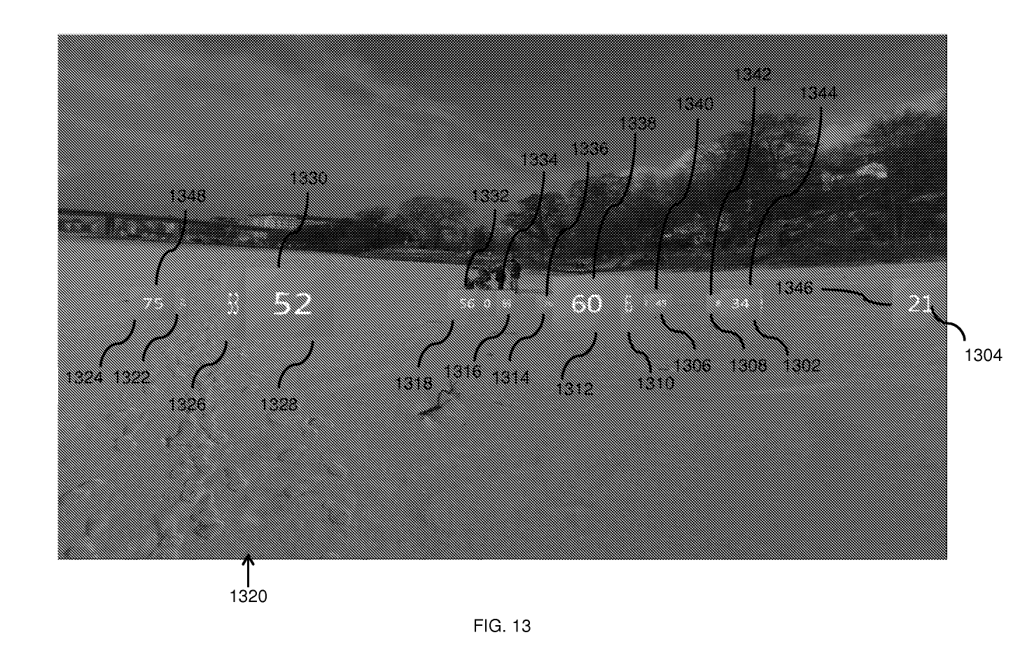

FIG. 11 shows 3D data objects 1102, 1004, 1108, 1110, 1112, and 1114 in a mixed reality 3D environment 1106. In this embodiment, the shape of each of the 3D data objects is represented by one side of a cube and its size is reflective of the quantity of the information contained within. The 3D coordinates of each object are identified in relation to its environment and to each other. For example, the 3D data objects 1108, 1110, and 1112 could be related files in the same folder in a 2D environment. Similarly, FIG. 12 shows 3D data objects 1204, 1206, 1208, 1210, 1212, 1214, 1216, 1218, 1220, and 1222 in a mixed reality 3D environment 1202, while FIG. 13 shows 3D data objects 1302, 1304, 1306, 1308, 1310, 1312, 1314, 1316, 1318, 1322, 1324, 1326, 1328, 1330, 1332, 1334, 1336, 1338, 1340, 1342, 1344, 1346, and 1348 in a mixed reality 3D environment 1320.

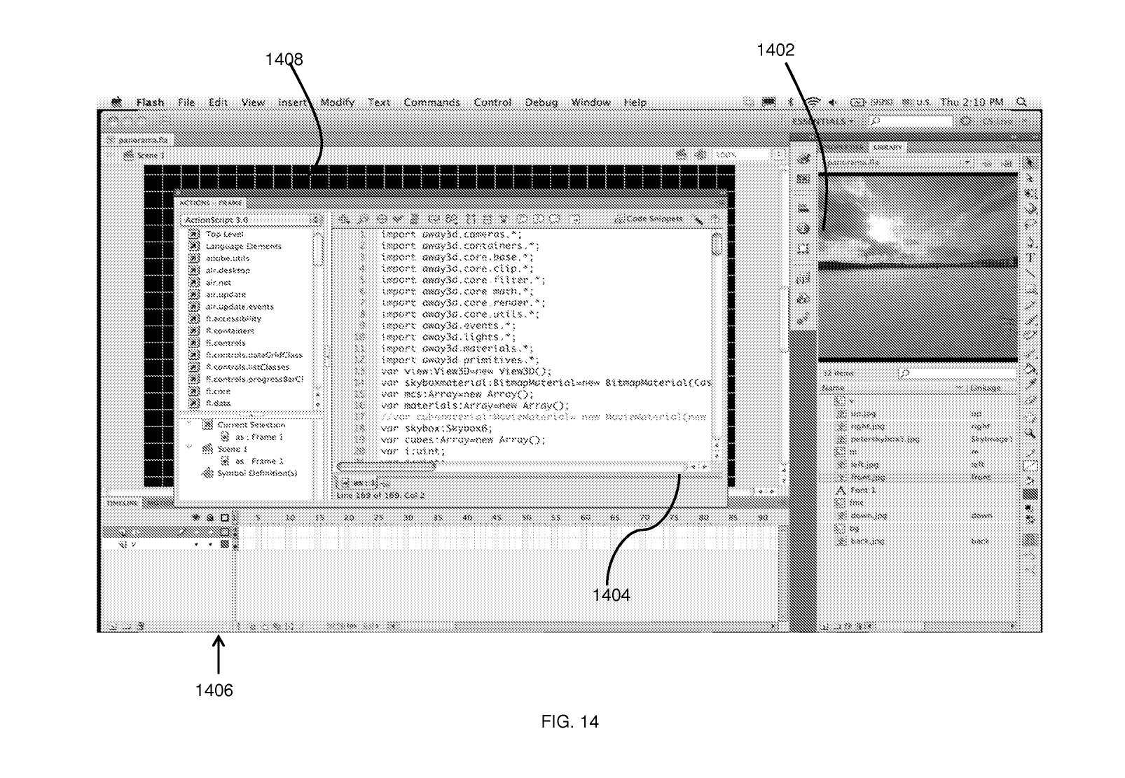

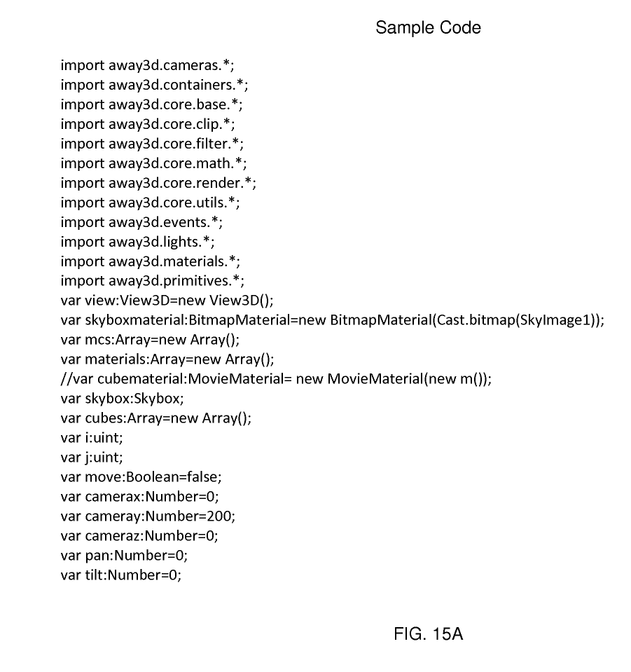

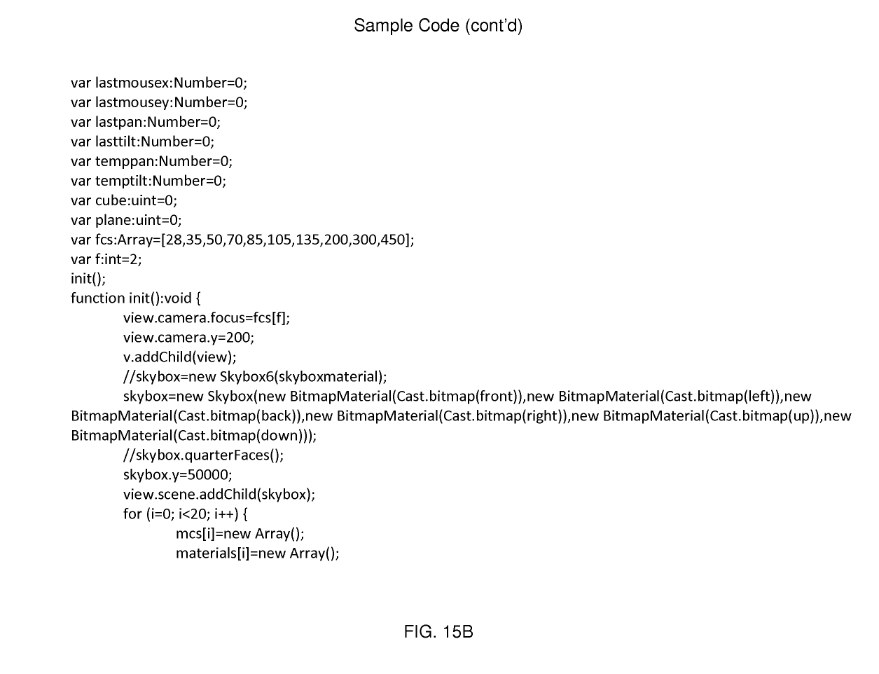

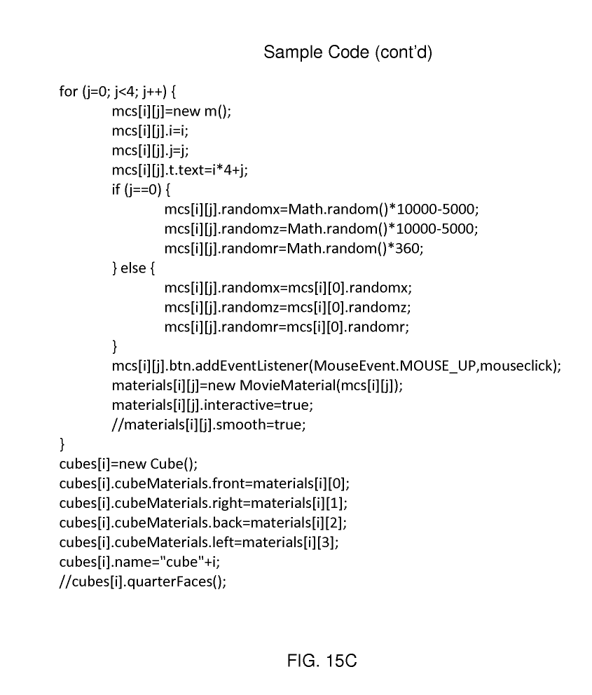

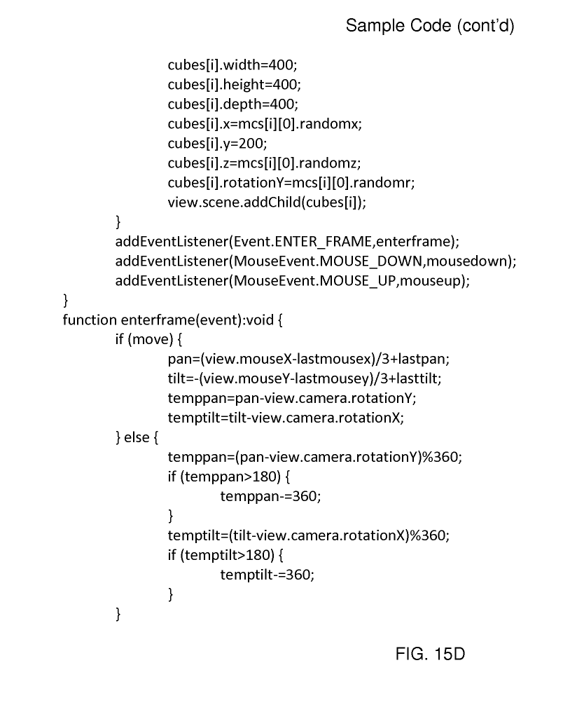

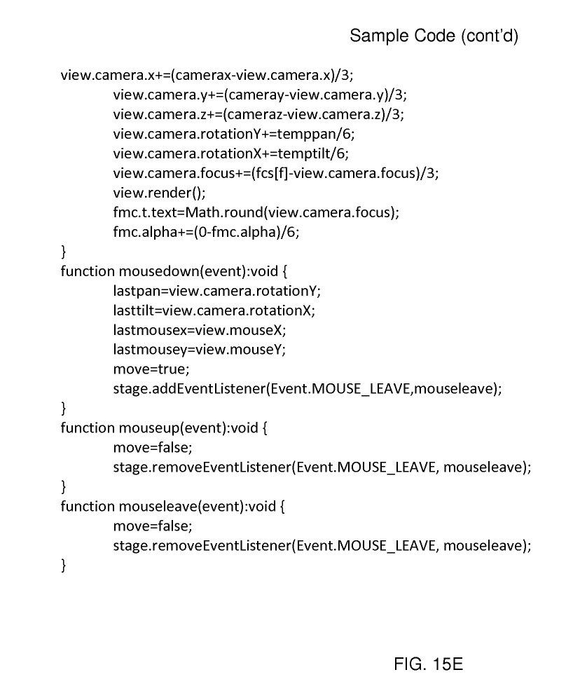

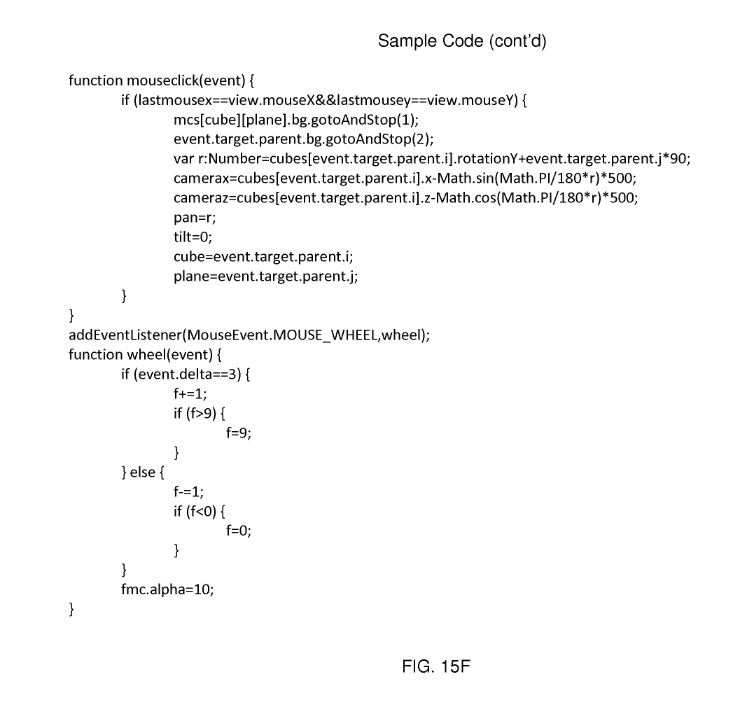

FIG. 14 is an exemplary screenshot 1406 of the Adobe Flash Code for the conversion software. A source code 1404 contains an exemplary portion shown in FIGS. 15A-15F. One of ordinary skilled in the art will recognize that other source codes written in the same or different programming language may achieve the same function. An object window 1402 shows certain picture files that may be displayed in a 3D environment 1408. The picture files may represent the background objects or the 3D data file objects converted from its 2D form.

One of ordinary skill in the art will recognize that a storage device may be any device capable of storing user-accessible digital data. For example, this information can be stored on computers, mobile and traditional phones, televisions, virtual reality environments and other types of electronic mediums. In addition, a display device may be any medium that is used by the user to interact with the 3D data objects. Such media may take many forms, including but not limited to a screen, mobile phone, virtual reality environment, or a computer.

While the present invention has been described in connection with various embodiments, other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A data conversion system, comprising:
A storage device for storing a user-accessible digital data, and
A conversion device for converting the user-accessible digital data into a 3D data object in a 3D environment,
wherein the 3D data object is capable of being created or modified by a user in the 3D environment; and
wherein a change made in the 3D data object by the user in the 3D environment is capable of being saved as the user-accessible digital data in the non-3D environment, the user-accessible digital data being capable of being further modified by the user in the non-3D environment.

2. The data conversion system of claim 1, wherein the conversion device is capable of dynamically converting the user-accessible digital data into the 3D data object in the 3D environment.

3. The data conversion system of claim 1, wherein the user-accessible digital data is a file data object.

4. The data conversion system of claim 3, wherein the file data object is an object that multiple files can relate in a defined order.

5. The data conversion system of claim 1, wherein the 3D environment can be displayed in at least one of a camera, a phone, a television, and a computer.

6. The data conversion system of claim 1, wherein the 3D environment is displayed on a screen.

7. The data conversion system of claim 1, wherein the 3D environment is displayed in a virtual reality environment.

8. A method for converting data, comprising:
storing a user-accessible digital data in a storage device, and
converting the user-accessible digital data into a 3D data object;
wherein the 3D data object is capable of being created or modified by a user in the 3D environment; and
wherein a change made in the 3D data object by the user in the 3D environment is capable of being saved as the user-accessible digital data in the non-3D environment, the user-accessible digital data being capable of being further modified by the user in the non-3D environment.

9. The method of claim 8, wherein converting the user-accessible digital data into the 3D data object further comprises dynamically converting into the 3D data object in the 3D environment.

10. The method of claim 8, wherein the 3D data object relates to the user's geometric space.

11. The method of claim 8, wherein the user-accessible digital data is a file data object.

12. The method of claim 11, wherein the file data object is an object that multiple files can relate in a defined order.

13. The method of claim 8, wherein the 3D environment can be displayed in at least one of a camera, a phone, a television and a computer.

14. The method of claim 8, wherein the 3D environment is displayed on a screen.

15. The method of claim 8, wherein the 3D environment is displayed in a virtual reality environment.

16. A 3D visualization system, comprising:
a display device configured to display a user-accessible digital data into a 3D data object in a 3D environment, the digital data not being an avatar of a user;
a 2D or 3D data object file storage device;
a computing device configured to program the 3D coordinates of the 3D data object in relation to the 3D environment; and
an input device configured to control the 3D data object in the 3D environment,
wherein the 3D data object is capable of being created or modified by the user in the 3D environment, and the corresponding user-accessible digital data can be stored in the computing device and modified by the user in a non-3D environment, and
wherein the input device is capable of being used to locate the 3D data object, zoom in and out the view, or navigate to other data objects.

17. The 3D visualization system of claim 16, wherein the user-accessible digital data is a data file object and the input device is capable of being used to locate and navigate to the data file object in the 3D environment.

18. The 3D visualization system of claim 16, wherein the 3D environment comprises both virtual and physical spaces.

19. The 3D visualization system of claim 16, wherein the input device is at least one of a mouse, a keyboard, a touch screen, a virtual reality sensor, a camera, and a device that can recognize controls by a human or a machine.

20. The 3D visualization system of claim 16, wherein the display device is at least one of a camera, a phone, a television, and a computer.

21. The 3D visualization system of claim 16, wherein the 3D environment is displayed on a screen.

22. The 3D visualization system of claim 16, wherein the 3D environment is displayed in a virtual reality environment.

23. A method for 3D visualization, comprising:
displaying a user-accessible digital data into a 3D data object in a 3D environment, the digital data not being an avatar of a user;
programming the 3D coordinates of the 3D data object in relation to the 3D environment; and
controlling the 3D object in the 3D environment,
wherein the 3D data object is capable of being created or modified by the user in the 3D environment, and the corresponding user-accessible digital data can be stored in the computing device and modified by the user in a non-3D environment, and
wherein controlling the 3D object further comprises locating the 3D data object, zooming in and out the view, or navigating to other data objects.

24. The method of claim 23, wherein the 3D data object relates to the user's geometric space.

25. The method of claim 23, wherein controlling the 3D data object in the 3D environment further comprises locating the 3D data object by navigating to the left or right.

26. The method of claim 23, wherein controlling the 3D data object in the 3D environment further comprises locating the 3D data object by navigating forward or backward.

27. The method of claim 23, wherein the user may control the 3D environment by rotating the scene of the 3D environment clockwise or counterclockwise.

28. The method of claim 23, wherein the user may control the 3D environment by ascending or descending the 3D data object within the 3D environment.

29. The method claim 23, wherein the 3D environment comprises both virtual and physical spaces.

30. The method of claim 23, wherein the user-accessible digital data is a file data object.

31. The method of claim 30, wherein the file data object is an object that multiple files can relate in a defined order.

32. The method of claim 23, wherein controlling the 3D object is done by at least one of a mouse, a keyboard, a touch screen, a virtual reality sensor, a camera, and a device that can recognize controls by a human or a machine.

33. The method of claim 23, wherein displaying the user-accessible digital data into a 3D data object in the 3D environment is done by at least one of a camera, a phone, a television, and a computer.

34. The method of claim 23, wherein the 3D environment is displayed on a screen.

35. The method of claim 23, wherein the 3D environment is displayed in a virtual reality environment.
